(19) United States
(12) Patent Application Publication
(10) Pub. No.: US 2026/0211742 A1
(43) Pub. Date: Jul. 23, 2026

(54) METHOD AND APPARATUS FOR SHARED RESOURCE MANAGEMENT

(71) Applicant: Dell Products L.P., Round Rock, TX (US)

(72) Inventors: Jay Jung, Shrewsbury, MA (US); Dharmesh J. Desai, Bangalore (IN); Peter Linden, Salt Lake City, UT (US)

(73) Assignee: Dell Products L.P., Round Rock, TX (US)

(21) Appl. No.: 19/035,160

(22) Filed: Jan. 23, 2025

(51) Int. Cl. G06F 9/50

(52) U.S. Cl. CPC G06F 9/505; G06F 2209/5011; G06F 2209/5019; G06F 2209/503

(57) ABSTRACT

A method for use in a computing system including a first component that is configured to allocate a resource of the computing system, the method including: calculating a long-term moving average of a supply of the resource; calculating a medium-term moving average of the supply of the resource; calculating a short-term moving average of the supply of the resource; detecting a trend of the supply of the resource based on the long-term moving average, the medium-term moving average, and the short-term average; and enabling a second component of the computing system for pre-allocating the resource based on an outcome of the detecting, wherein the second component is enabled in response to the detected trend being a convergent trend, wherein the second component is configured to at least in part supplement the functions of the first component.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method for use in a computing system including a first component that is configured to allocate a resource of the computing system, the method comprising: calculating a long-term moving average of a supply of the resource; calculating a medium-term moving average of the supply of the resource; calculating a short-term moving average of the supply of the resource; detecting a trend of the supply of the resource based on the long-term moving average, the medium-term moving average, and the short-term average; and enabling a second component of the computing system for pre-allocating the resource based on an outcome of the detecting, wherein the second component is enabled in response to the detected trend being a convergent trend, wherein the second component is configured to at least in part supplement the functions of the first component.

According to aspects of the disclosure, a system is provided, comprising: a memory; and at least one processor that is operatively coupled to the memory, the at least one processor being configured to perform the operations of: executing a first component of the system that is configured to allocate a resource of the system; calculating a long-term moving average of a supply the resource; calculating a medium-term moving average of the supply of the resource; calculating a short-term moving average of the supply of the resource; detecting a trend of the supply of the resource based on the long-term moving average, the medium-term moving average, and the short-term average; and enabling a second component of the system for pre-allocating the resource based on an outcome of the detecting, wherein the second component is enabled in response to the detected trend being a convergent trend, wherein the second component is configured to at least in part supplement the functions of the first component.

According to aspects of the disclosure, a non-transitory computer-readable medium is provided storing one or more processor-executable instructions, which, when executed by at least one processor of a system, cause the at least one processor to perform the operations of: executing a first component of the system that is configured to allocate a resource of the system; calculating a long-term moving average of a supply of the resource; calculating a medium-term moving average of the supply of the resource; calculating a short-term moving average of the supply of the resource; detecting a trend of the supply of the resource based on the long-term moving average, the medium-term moving average, and the short-term average; and enabling a second component of the system for pre-allocating the resource based on an outcome of the detecting, wherein the second component is enabled in response to the detected trend being a convergent trend, wherein the second component is configured to at least in part supplement the functions of the first component.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1A is a diagram of an example of a system, according to aspects of the disclosure;

FIG. 1B is a diagram of an example of a storage system, according to aspects of the disclosure;

FIG. 2 is a diagram of an example of a process, according to aspects of the disclosure;

FIG. 3 is a diagram of an example of a process, according to aspects of the disclosure;

FIG. 4 is a graph of the supply and demand curves of a resource when a secondary resource allocator is not used, according to aspects of the disclosure;

FIG. 5 is a graph of the supply and demand curves of a resource when a secondary resource allocator is used, according to aspects of the disclosure;

FIG. 6A is a graph illustrating an example of a divergence trend, according to aspects of the disclosure;

FIG. 6B is a graph illustrating an example of a convergence trend, according to aspects of the disclosure;

FIG. 7 is a flowchart of an example of a process, according to aspects of the disclosure;

FIG. 8 is a flowchart of an example of a process, according to aspects of the disclosure;

FIG. 9 shows an example of a model for evaluating consistency, according to aspects of the disclosure;

FIG. 10 shows an example of a model for evaluating accuracy, according to aspects of the disclosure; and

FIG. 11 is a diagram of an example of a computing device, according to aspects of the disclosure.

### DETAILED DESCRIPTION

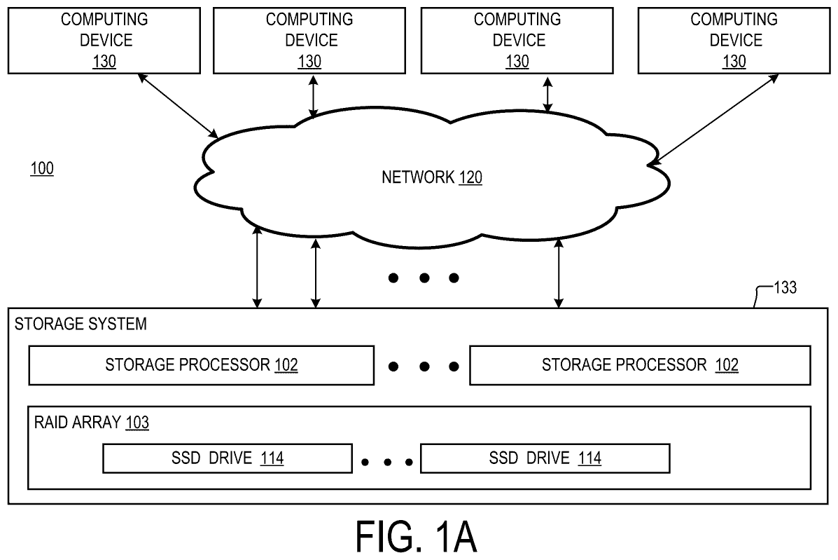

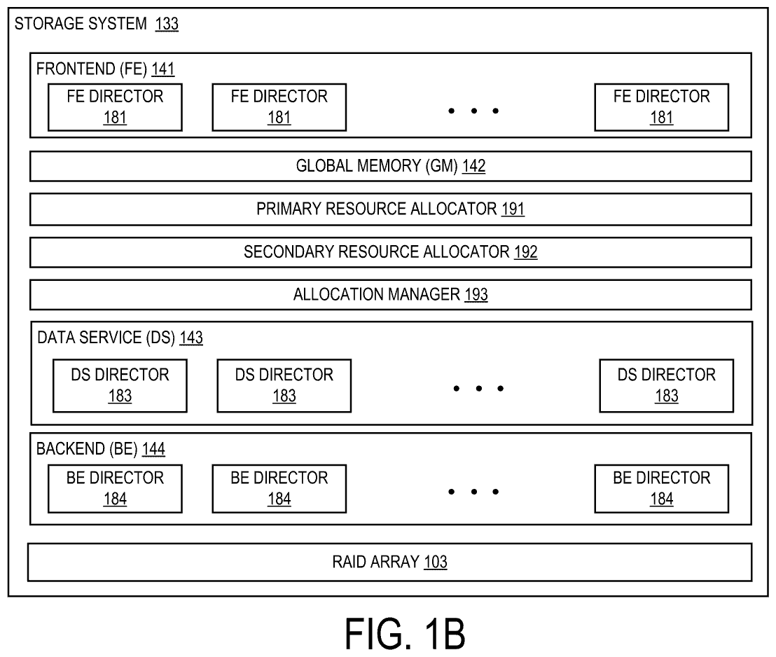

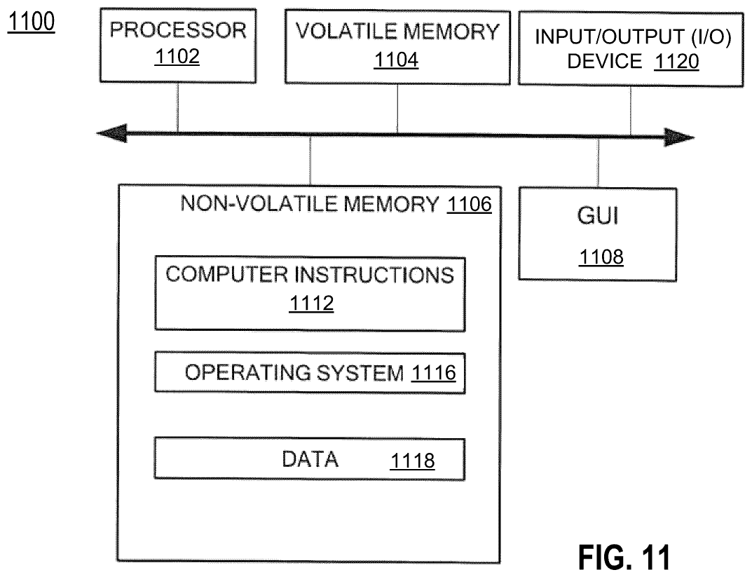

FIG. 1A is a diagram of an example of a system 100, according to aspects of the disclosure. As illustrated, system 100 may include a storage system 133 that is coupled to a plurality of computing devices 130 via a communications network 120. Each of the computing devices 130 may include a smartphone, a desktop, a server, a laptop, and/or any other device that might be used by a user to store and retrieve data from the storage system 133. Each of the computing devices 130 may be the same or similar to the computing device 1100, which is discussed further below with respect to FIG. 11. The communications network 120 may include one or more of the Internet, a local area network (LAN), a wide area network (WAN), an InfiniBand network, a mobile data network, etc. Storage system 133 may include a plurality of storage processors 102 and a plurality of storage devices 114. In some implementations, each of the storage devices 114 may include a Solid-State Drive (SSD), a Non-Volatile Memory Express (NVME) device, a hard disk, and/or any other suitable type of storage device. According to the present example, the storage devices are arranged in a RAID array 103. Each of the storage processors 102 may include a computing device, such as the computing device 1100, which is discussed further below with respect to FIG. 11. Each of the storage processors 102 may be configured to receive I/O requests from the computing devices 130 and execute the received requests by reading or writing data to the RAID array 103.

FIG. 1B is a diagram illustrating aspects of the operation of storage system 133, according to aspects of the disclosure. As illustrated, the storage system 133 may include a frontend (FE) 141, a global memory (GM) 142, a data service (DS) 143, a backend (BE) 144, a primary resource allocator 191 (hereinafter allocator 191), a secondary resource allocator (hereinafter “allocator 192”), and an allocation manager 193 (hereinafter “manager 193”. FE 141 may be comprised of one or more FE directors 181. Each FE director 181 may include one or more processes that are executed on a respective one of the storage processors 102. DS 143 may be comprised of one or more DS directors 183. Each DS director 183 may include one or more processes that are executed on a respective one of the storage processors 102. BE 144 may be comprised of one or more BE directors 184. Each BE director 184 may include one or more processes that are executed on a respective one of the storage processors 102. GM 142 includes a shared memory space that is used by storage system 133 for caching data. GM 142 may include a plurality of memory portions that are united in the same address space, wherein each of the plurality of memory portions is part of the volatile memory (e.g., DRAM) of a different respective one of the storage processors 102. Although, in the present example, GM 142 is used to cache data, it will be understood that alternative implementations are possible in which GM 142 is replaced with a different type of cache memory. In other words, the present disclosure is not limited to using any specific type of cache memory. Further information about the architecture shown in FIGS. 1A-B can be found in U.S. patent application Ser. No. 18/820,867, entitled INTELLIGENT RELOCATION DESTAGE, which is hereby incorporated by reference herein in its entirety.

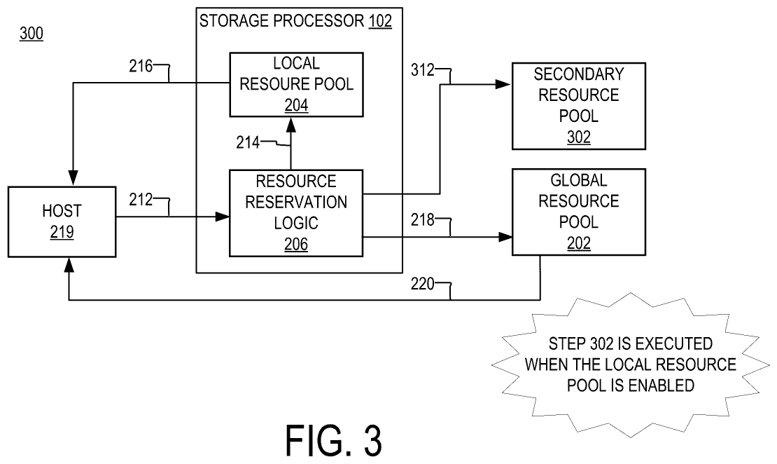

Allocator 191 may include logic or a component of storage system 133 that is configured to allocate a resource. Specifically, allocator 191 may pre-allocate a resource to a resource pool, such as the global resource pool 202 (shown in FIG. 3), from where the resource can be assigned to different threads or processes in storage system 133, such as threads that are used to implement FE directors 181, DS directors 183, and BE directors 181. According to the present example, allocator 191 is implemented in software. However, alternative implementations are possible in which allocator 191 is implemented in hardware or as a combination of software and hardware. According to the present example, the resource is memory used for message buffers. The message buffers are used in inter-process communication between different threads or processes. However, alternative implementations are possible in which the resource is cache memory used to define cache slots, central processing unit (CPU) time, and or any other suitable type of computing resource. The concepts and ideas described throughout the disclosure can be applied to any computing resource, and they are not limited to the examples above.

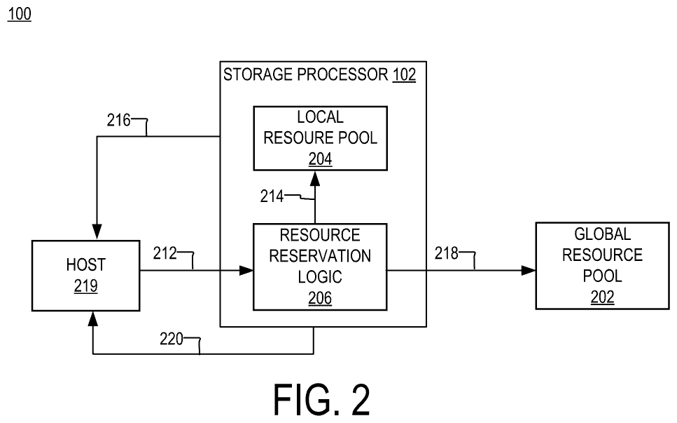

Allocator 192 may include logic or a component of storage system 133 that is configured to pre-allocate the same resource as allocator 191. Allocator 192 may be arranged to supplement the functions of allocator 191 and allocate additional amounts of the resource when allocator 191 is unable to keep up with demand. According to the present example, allocator 192 pre-allocates the resource into a secondary resource pool 302 (shown in FIG. 3.) However, alternative implementations are possible in which allocator 192 allocates the resource into the global resource pool 202 or the local resource pool 204 (shown in FIG. 2). According to the present example, allocator 192 is implemented in software executed on any of storage processors 102 and/or any other computing device that is part of storage system 133. However, alternative implementations are possible in which allocator 192 is implemented in hardware or as a combination of hardware and software.

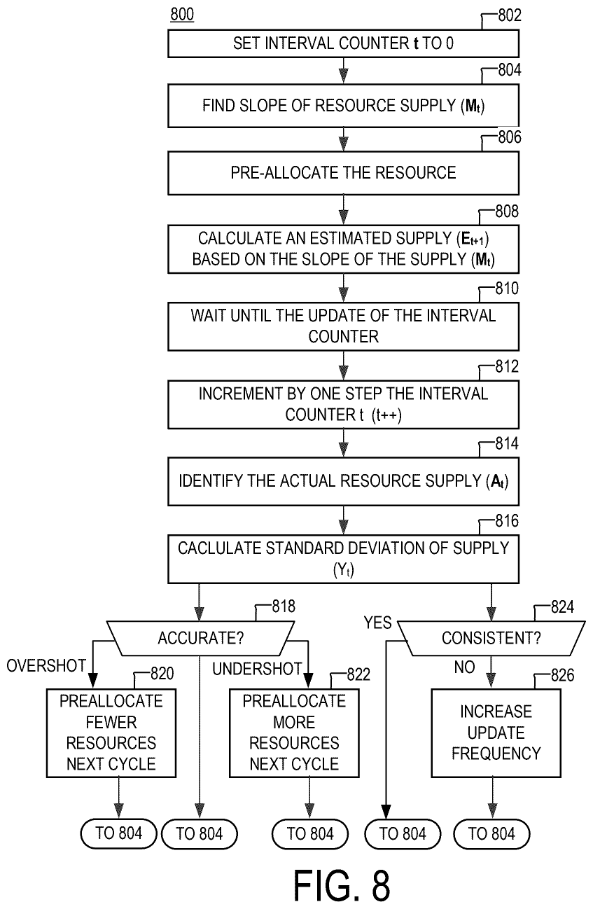

For ease of description, the action of the allocator 191 is referred to as “pre-allocation of a resource,” and it involves making a certain amount of the resource available in a resource pool from where the resource (or portions thereof) can be further assigned or allocated to different threads and processes in storage system 133. For ease of description, the action of the allocator 192 is referred to as “pre-allocation of a resource,” and it involves making a certain amount of the resource available in a resource pool from where the resource (or portions therefor) can be further assigned or allocated to different threads and processes in storage system 133. In some implementations, allocator 192 may be configured to perform a process 800, which is discussed further below with respect to FIG. 8.

In some implementations, each of the resource pools 202, 204, and 302 may include logic for allocating the resource. The logic may keep track of which resource items in the pool (e.g., memory addresses, CPU cores, cache slots, etc.) are already assigned to threads or processes and which are free to be assigned. The logic may be arranged to receive an allocation request for the resource and fulfill the request in a well-known fashion. The logic may be implemented in software, hardware, or a combination of hardware or software. The logic may be executed on any of the computing devices that are part of the storage system 133. The phrase “pre-allocating a resource to a pool” refers to any action that makes the resource available for the pool's logic to assign to threads or processes.

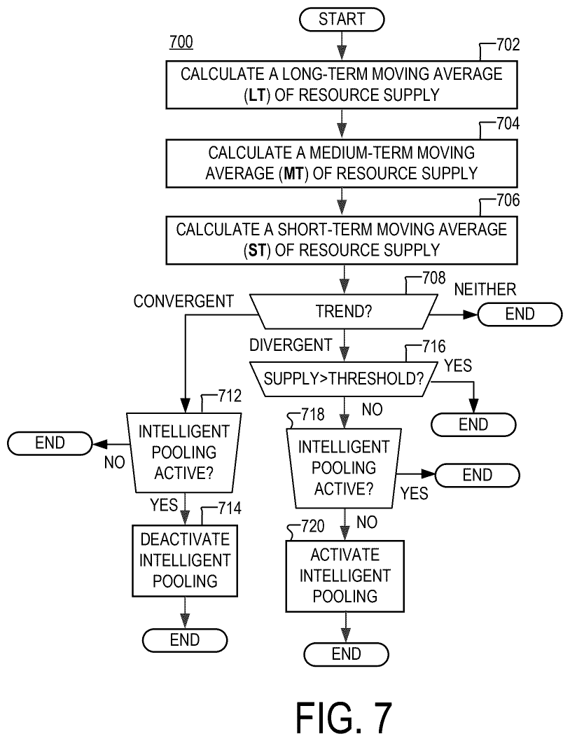

Manager 193 may be configured to selectively turn the allocator 192 on and off. In some implementations, manager 193 may be configured to perform a process 700 which is discussed further below with respect to FIG. 7.

FIG. 2 is a diagram of an example of a process 200 that is performed by storage system 133, according to aspects of the disclosure. In the example of FIG. 2, allocator 192 is not used, and all allocation of the resource is performed by allocator 191. Shown in FIG. 2 is a host 219 and one of the storage processors 102, which are part of storage system 133. Host 219 may be any process, thread, or other entity in storage system 133 which is operable to reserve the resource from one of the global resource pool 202 and the local resource pool 204. Although host 219 is depicted as a separate block from storage processor 102, in some implementations, host 219 may be a process that is executed on storage processor 102. The difference between the global resource pool 202 and the local resource pool 204 is that pool 202 is accessible by all storage processors in storage system 133. In contrast, pool 204 is accessible only to the storage processor depicted in FIG. 2 (i.e., the storage processor in whose memory it is instantiated). The storage processor 102 (shown in FIG. 2) is configured to execute a resource reservation logic 206 that is arranged to reserve the resource for use by different processes that are executed on the storage processor 102. Logic 206 may be implemented in software, hardware, or a combination of software and hardware.

Process 200 is now described in further detail. At step 212, resource reservation logic 206 receives from host 219 a request for the reservation of a resource. According to the present example, the resource is a message buffer, and the request is for the reservation of a message buffer for use by host 219. At step 214, resource reservation logic 206 attempts to allocate the resource from pool 204, but it fails. At step 216, storage processor 102 returns a “pool depleted-retry” message to host 219. At step 218, resource reservation logic 206 attempts to allocate the resource from pool 202, but it fails. At step 220, storage processor 102 transmits a “pool depleted-retry” message to host 191. At this point, the host 219 determines that the resource is depleted, and its action needs to be suspended until the resource becomes available. In general, host 219 may request the resource when an incoming input-output (IO) request is received at the storage system 133, and host 219 is assigned to service the IO request. In this regard, the lack of available resources in pools 202 and 204 may prejudice the ability of storage system 133 to service incoming I/O requests in a prompt fashion. When IOs can no longer be serviced, the latency of storage system 133 spikes, and storage system 133 incurs a performance penalty.

FIG. 3 is a diagram of an example of a process 300 that is performed by storage system 133, according to aspects of the disclosure. In the example of FIG. 3, allocator 192 is used to supplement the resource pre-allocation functions of allocator 191. Specifically, allocator 192 is arranged to pre-allocate the resource into a secondary resource pool 302. The secondary resource pool 302 may be allocated in GM 142 and/or the local memory of storage processor 102. Process 300 is nearly identical to process 200 but for including a step 312. Step 312 is performed after logic 206 has failed to reserve the resource from the global resource pool 202 and the local resource pool 204. At step 312, logic 206 successfully reserves the resource from the secondary resource pool 302. Because the resource is successfully reserved, storage system 133 does not incur a performance penalty in the way it does in the example of FIG. 2. FIG. 3 shows that the provision of allocator 192 in storage system 133 is advantageous because it may help avoid situations in which storage system 133 runs out of available resources and incurs a performance penalty as a result.

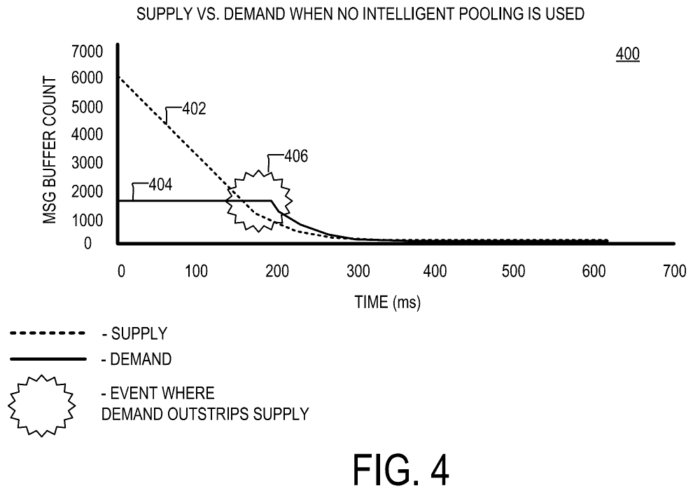

FIG. 4 includes a plot 400 of the supply and demand curves for the resource when allocator 192 is not used to supplement the functions of allocator 191. As used throughout the disclosure, the term “supply” refers to the total amount of resource, or total number of resource items (such as message buffers), which is currently pre-allocated in each (or at least one) of pools 202, 204, and 302, and which are is currently assigned to, or reserved for use by, a particular thread or process. In other words, the term “supply” refers to only those portions of the resource that have been pre-allocated into one or more of the pools 202, 204, and 302 and which are currently available to be allocated to threads and processes. As used throughout the disclosure, the term “demand” refers to the amount of resource or number of resource items (such as message buffers), which is currently being requested by processes and threads in storage system 133.

In the example of FIG. 4, the resource is message buffers. The Y-axis represents the number of message buffers (or message buffer count), and the X-axis represents time. The supply of message buffers is shown by curve 402, and the demand for message buffers is shown by curve 404. The demand for message buffers corresponds to the current load on storage system 133, which is measured in received IOs per second (IOPS). The message buffers are used for purposes of inter-process communication that is performed by FE directors 181, DS directors 183, and BE directors 184, and other entities over the course of servicing the I/O requests.

In region 406 of plot 400, around time=200 ms, the demand outpaces the supply. At this point, storage system 133 begins to throttle itself—i.e., it begins to reject any incoming IOs right away. As a result of this action, the demand for the resource drops below the supply, but storage system 133 also suffers a performance penalty by way of increased response time resulting from storage system 133 not servicing promptly incoming IO requests. Plot 400 is provided to illustrate an example of one negative scenario that can develop when allocator 192 is not used to supplement the function of allocator 191, the negative scenario being that storage system 133 may start to throttle itself and experience an increased response time as a result.

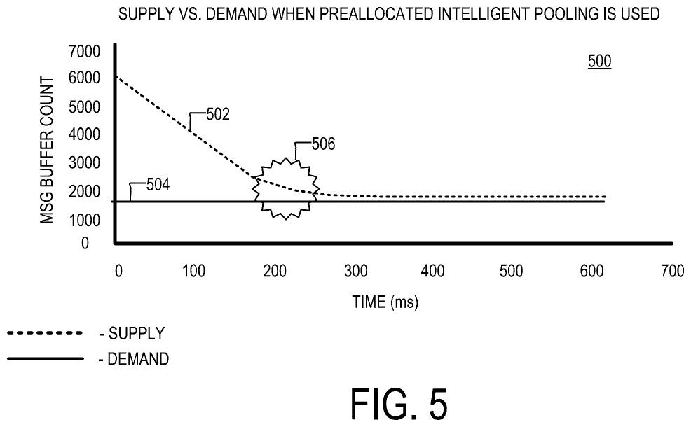

FIG. 5 includes a plot 500 of the supply and demand curves for the same resource as plot 400. Plot 500 shows the supply and demand curves that develop when allocator 192 is used to supplement the function of allocator 191. FIG. 5 shows a supply curve 502 and a demand curve 504 for the resource. When the demand begins to approach the supply for the resource (in region 506 of plot 500), allocator 192 is turned on, and the supply of the resource is maintained at a stable level, above demand. As a result, no throttling is performed by storage system 133, and the demand for the resource remains flat. Plot 500 illustrates that when allocator 192 is provided in storage system 133, the operation of allocator 192 may cause storage system 133 to maintain a stable supply of the resource, which is higher than demand, and which in turn can prevent storage system 133 from suffering the adverse impact on performance that results from the resource not being sufficiently pre-allocated and storage system 133 having to throttle itself.

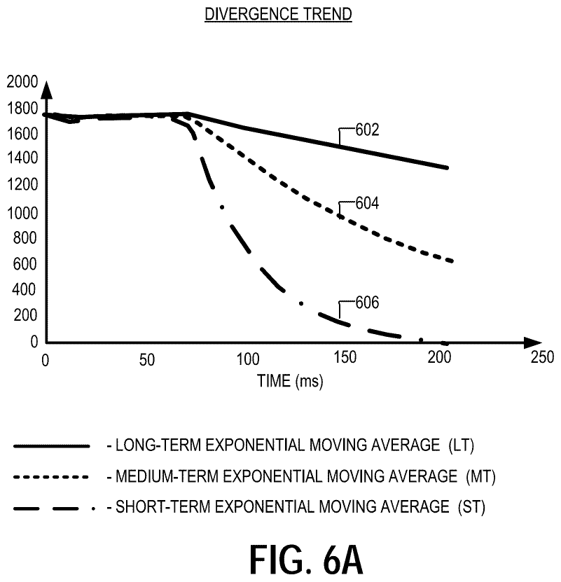

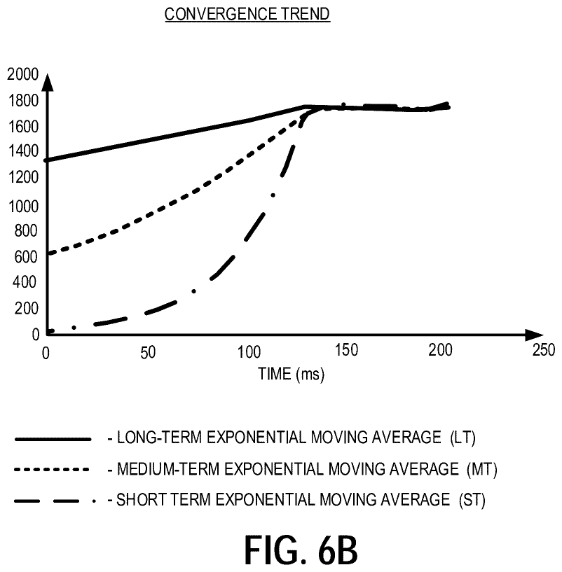

FIG. 6A-B illustrate plots of the respective long-term, short-term, and medium-term exponential moving averages of the supply of the resource. Curve 602 shows the long-term exponential moving average (LT) of the supply; curve 604 shows the medium-term (MT) exponential moving average of the supply; and curve 606 shows the short-term exponential moving average (ST) of the supply. In one example, the long-term moving average is calculated over a period equal in length to 200 update intervals, the medium-term moving average is calculated over a period equal in length to 50 update intervals, and the short-term moving average is calculated over a period equal to 14 update intervals. An update interval is the period at which allocator 192 performs one round of pre-allocation of the resource. In one example, the update interval is equal to 5 ms. The present disclosure is not limited to any specific duration for the update interval or the periods in which the short-term, medium-term, and long-term exponential moving averages are calculated.

FIG. 6A shows an example in which the supply of the resource is subject to a divergent trend. As can be readily appreciated, a divergent trend is a condition in which the respective long-term, medium-term, and short-term exponential moving averages of the resource supply begin to drift away from each other. The presence of a divergence trend signals that the resource demand outpacing the resource supply. Manager 193 may be configured to calculate the long-term, medium-term, and short-term moving averages in each update interval and detect whether a divergent trend is present. When allocator 192 is disabled, and if a divergent trend is present, manager 193 may turn on (or enable) allocator 192. Otherwise, when allocator 192 is disabled, and if no divergent trend is present, manager 193 may allow allocator 192 to remain disabled. In one example, manager 193 may detect whether a divergent trend is present by calculating the current values of ST, MT, and LT. Next, manager 193 may compare the values of ST, MT, and LT. If ST is less than MT, and MT is less than LT, manager 193 may determine that a convergence trend is present (i.e., if ST<MT<LT then a divergent trend is present; else no divergent trend is present). Alternatively, if the difference between MT and ST is above a first threshold T1, and if the difference between LT and MT is above a second threshold T2, manager 193 may determine that a divergent trend is present (i.e., if (MT-ST)>T1 && (LT-MT)>T2) then a divergent trend is present; else no divergent trend is present). In this example, threshold T2 is greater than threshold T1 (i.e., T2>T1).

FIG. 6B shows an example in which the supply of the resource is subject to a convergent trend. As can be readily appreciated, a convergent trend is a condition in which the respective long-term, medium-term, and short-term exponential moving averages of the resource supply begin to approach each other. The presence of a convergence trend signals that the resource supply is keeping up with the resource demand. Manager 193 may be configured to calculate the long-term, medium-term, and short-term moving averages in each update interval and detect if a convergent trend is present. When allocator 192 is enabled, and if a convergent trend is present, manager 193 may turn off (or disable) allocator 192. Otherwise, when allocator 192 is enabled, and if no convergent trend is detected, manager 193 may allow allocator 192 to remain enabled. In one example, manager 193 may detect whether a convergent trend is present by calculating the current values of ST, MT, and LT. Next, manager 193 may compare the values of ST, MT, and LT. If ST is equal to MT, and MT is equal to LT, manager 193 may determine that a convergence trend is present (i.e., if ST==MT==LT then a convergent trend is present; else no convergent trend is present). Alternatively, if the difference between MT and ST is less than a first threshold T1, and if the difference between LT and MT is less than a second threshold T2, manager 193 may determine that a convergent trend is present (i.e., if (MT−ST)<T1 && (LT−MT)<T2 then a convergent trend is present; else no convergent trend is present;). In this example, threshold T2 is greater than threshold T1 (i.e., T2>T1). The value of threshold T1, in the example of FIG. 6B, may be the same as the value of threshold T1 from the example of FIG. 6A. The value of threshold T2, in the example of FIG. 6B, may be the same as the value of threshold T2 from the example of FIG. 6A.

FIG. 7 is a flowchart of an example of a process 700, according to aspects of the disclosure. In the example of FIG. 7, process 700 is performed by manager 193. However, the present disclosure is not limited to any specific entity or group of entities performing the process 700.

At step 702, the long-term exponential moving average (LT) of the resource supply is calculated.

At step 704, the medium-term exponential moving average (MT) of the resource supply is calculated.

At step 706, the short-term exponential moving average (ST) of the resource supply is calculated.

At step 708, a determination is made whether the resource is subject to a convergent trend or a divergent trend. The determination may be made based on the values of LT, MT, and ST, which are obtained at steps 702, 704, and 706. The determination can be made in the manner discussed above with respect to FIGS. 6A-B. If the resource is found to be subject to a convergent trend, process 700 proceeds to step 712. If the resource is found to be subject to a divergent trend, process 700 proceeds to step 716. Otherwise, if the resource is found to be neither subject to a convergent trend nor a divergent trend, process 700 ends.

At step 712, a determination is made if intelligent pooling is active in storage system 133. The determination involves detecting whether allocator 192 is currently enabled or active. The determination may be made based on the value of a status indicator variable for allocator 192, which is stored in the memory of one or more computing devices that are part of the storage system 133. Alternatively, the determination may be made by examining the status of one or more threads or processes that are used to implement allocator 192. If the threads are suspended, allocator 192 may be considered inactive. If the threads have a “running” status, allocator 192 may be considered active. If allocator 192 is found to be active, process 700 proceeds to step 714. Otherwise, if allocator 192 is found to be inactive, process 700 proceeds to step 714.

At step 714, intelligent pooling is deactivated. Deactivating the intelligent pooling may include taking any suitable action that would cause the allocator 192 to stop operating. In one example, deactivating intelligent pooling may include setting the status variable to indicate that allocator 192 is inactive. In another example, deactivating intelligent pooling may include terminating one or more threads that implement allocator 192. In yet another example, deactivating intelligent pooling may include transitioning one or more threads that implement allocator 192 from a running state into a suspended state. In yet another example, deactivating intelligent pooling may include causing allocator 192 to stop executing a process 800, which is discussed with respect to FIG. 8.

At step 716, the current value of the resource supply is determined and a determination is made as to whether the value for the resource supply is above a supply threshold. According to the present example, the supply threshold is equal to a value that is equal to 165% of the value at which the supply of the resource would be considered depleted. For example, the value at which the resource would be considered depleted is equal to the current demand value for the resource. However, it will be understood that the present disclosure is not limited to any specific method for defining the supply threshold for as long as the supply threshold is greater than the level at which the supply would be considered depleted. If the supply is greater than the supply threshold, process 700 ends. Otherwise, if the supply is not greater than the supply threshold, process 700 proceeds to step 718.

At step 718, a determination is made as to whether intelligent pooling is active in storage system 133. The determination is made in the manner discussed with respect to step 712.

At step 720, intelligent pooling is activated in storage system 133. Activating the intelligent pooling may include taking any suitable action that would cause the allocator 192 to begin operating. In one example, activating intelligent pooling may include setting the status variable to a value indicating that allocator 192 is active. In another example, activating intelligent pooling may include instantiating one or more threads that implement allocator 192. In yet another example, activating intelligent pooling may include transitioning one or more threads that implement allocator 192 from the suspended state into the running state. In yet another example, activating intelligent pooling may include causing allocator 192 to begin (or resume) executing process 800, which is discussed with respect to FIG. 8.

In some implementations, the supply threshold (used in step 716) may be set dynamically. For example, manager 193 may calculate the long-term (LTD), medium-term (MTD), and short-term (STD) exponential moving averages of the demand for the resource. The averages may be calculated over periods of 200 update intervals, 50 update intervals, and 14 update intervals, respectively. Next, manager 193 may determine if the respective value of each of LTD, MTD, and STD is at a historic high. If each of the exponential moving average values (e.g. LTD, MTD, and STD) is at a historic high, manager 193 may increase the value of the supply threshold (e.g., by 5% or another step). Alternatively, manager 193 may determine if the respective value of each of LTD, MTD, and STD is at a historic low. If each of the average values is (e.g. LTD, MTD, and STD) is at a historic low, manager 193 may decrease the value of the supply threshold (e.g., by 5% or another step).

FIG. 8 is a flowchart of an example of a process 800, according to aspects of the disclosure. According to the example of FIG. 8, process 800 is performed by allocator 192. However, the present disclosure is not limited to any specific entity or group of entities performing process 800.

At step 802, a new update interval begins, and the value of an update interval counter t is set to 0(t=0 ).

At step 804, allocator 192 calculates the slope Mₜ of the supply of the resource. The slope value may be determined by sampling or otherwise measuring the supply of the resource at different time instants before and/or after step 802 is executed. The slope value is measured by amount of resource (or count of resource items) per update interval. In the present example, the slope value Mₜ indicates by how many message buffer the supply of available message buffers would increase or decrease. In other words, the Mₜ may be a positive or negative number (or zero). In some implementations, the slope may be determined by using linear regression.

At step 806, allocator 192 pre-allocates the resource. Pre-allocating the resource may include making an additional amount of the resource available in the secondary resource pool 302 (shown in FIG. 3) and/or any of the resource pools 202 and 204 (shown in FIG. 3). The additional amount of the resource that is brought into any of the resource pools may be determined based on the value Mt. As noted above, according to the present example, the resource is a message buffer that is used for inter-process communication. In the present example, a certain count of message buffers is brought into the resource pool 302. The count may be determined by rounding down the value of k*Mₜ, where k is a scaling constant. In other words, if Mt=3, 3 message buffers would be brought into the resource pool 302 (assuming k=1). On the other hand, if Mₜ is less than or equal to zero, no additional message buffers may be brought into the resource pool 302. The phrase bringing a message buffer into the resource pool may include: (i) placing a lock on a portion of GM 142 or other memory of storage system 133, such as the local memory of a storage processor 102, and (ii) transmitting an instruction to the logic that is part of the resource pool which notifies the logic that it can allocate parts of the reserved memory portion as message buffers.

At step 808, allocator 192 calculates an estimate Eₜ₊₁ of the resource supply. The estimate is the value of the resource supply, which is expected to be available at the onset of the next update interval. The estimate may be made by using linear regression. The estimate may be based on the slope value Mₜ (determined at step 804) and the current demand for the resource. As can be readily appreciated, in one example, the estimate may be determined in accordance with the equation of Eₜ₊₁=CS+Mₜ, where CS is the current supply of the resource (e.g., the supply of the resource during the update interval t, etc.). As can be readily appreciated, the value of Mt may represent the net of resources freed and the resources acquired (e.g. demand). The present disclosure is not limited to any specific method for calculating the estimate.

At step 810, allocator 192 waits until the current update interval has ended. In the present example, the current update interval has a duration of 5 ms. However, the present disclosure is not limited to any specific duration for the update interval.

At step 812, allocator 192 increments interval counter t by one (t++).

At step 814, allocator 192 determines the supply of the resource that is currently available at the time when step 814 is executed. The determination may be made by querying one or more of resource pools 202, 204, and 302.

At step 816, allocator 192 calculates the standard deviation Yₜ of the resource supply. The standard deviation may be calculated over the respective values of the resource supply in each of a plurality of previous update intervals, as well as the resource supply value for the current update interval (determined at step 814).

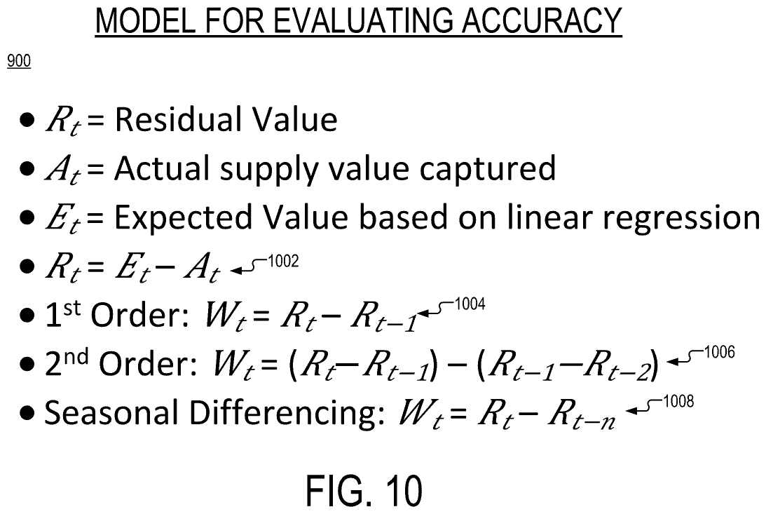

At step 818, allocator 192 determines if the estimate (made at step 808) was an overshot estimate or an undershot estimate. If the estimate was an overshot estimate, process 800 proceeds to step 820. If the estimate was an undershot estimate, process 800 proceeds to step 822. Otherwise, if the estimate was neither an overshot nor an undershot, process 800 returns to step 804. In some implementations, step 818 may be performed by executing the model discussed further below with respect to FIG. 10.

At step 820, allocator 192 adjusts its operation so that the next time step 806 is executed, a smaller amount of the resource or fewer resource items (e.g., fewer message buffers) is allocated than in the current update interval. For example, the allocator 192 may reduce by 5% (or another fraction) the value of the scaling constant k (used in step 806). After step 820 is completed, process 800 returns to step 804.

At step 822, allocator 192 adjusts its operation so that the next time step 806 is executed, a larger amount of the resource or more resource items (e.g., more message buffers) is allocated than in the current update interval. For example, allocator 192 may increase by 5% (or another fraction) the value of the scaling constant k (used in step 806). After step 822 is completed, process 800 returns to step 804.

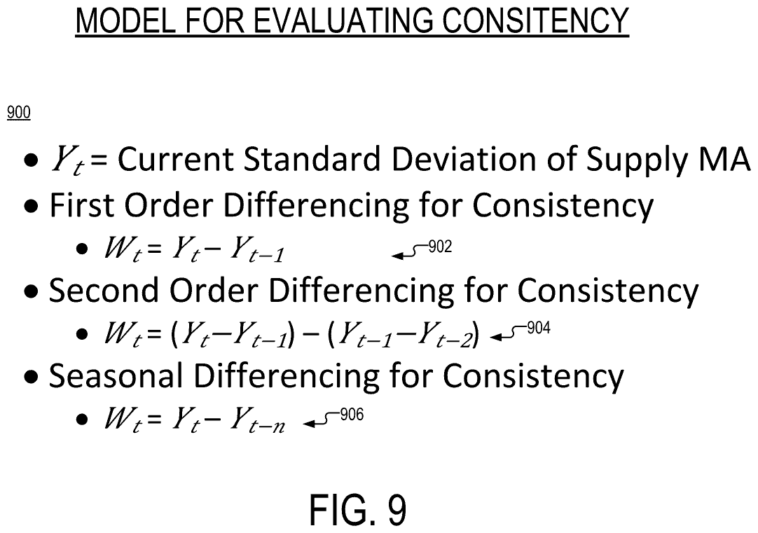

At step 824, allocator 192 determines if the estimate (made at step 808) is consistent. If allocator 192 determines that the estimate has a good consistency, process 800 returns to step 804. Otherwise, if allocator 192 determines that the estimate has poor consistency, process 800 proceeds to step 826. In some implementations, step 824 may be performed by executing the model discussed further below with respect to FIG. 9.

At step 826, allocator 192 increases the frequency at which the resource is pre-allocated. Specifically, to increase the update frequency, allocator 192 may decrease the length of the update interval (e.g., by 5%). After step 826 is completed, process 800 returns to step 804.

A discussion is now provided of different models for assessing consistency, as specified by step 824 of process 800 (shown in FIG. 8). In one example, step 824 may be executed by calculating the difference (E−A) between the estimated supply E (determined at the most recent iteration of step 808) and the actual supply (determined at the most recent iteration of step 814). If the absolute value of the difference is less than or equal to the standard deviation value Y (determined at the most recent iteration of step 816), allocator 192 may determine that the estimate E (determined during the most recent iteration of step 808) has a good consistency, in which case process 800 would skip step 826 and return to step 808 directly. If the absolute value of the difference is greater than the standard deviation value Y (determined at the most recent iteration of step 816), allocator 192 may determine that the estimate E (determined during the most recent iteration of step 808) has poor consistency, in which case process 800 would execute step 826 before returning to step 808.

FIG. 9 provides an example of a model 900, which can be used to access consistency with greater precision. Model 900 defines a variable Wₜ, which measures the amount of white noise that is present in the standard deviation Y that is calculated at different iterations of step 816. The index of the standard deviation identifies the update interval in which the standard deviation was calculated. In this regard, Yₜ is the standard deviation calculated during the current update interval, Yₜ₋₁ is the standard deviation calculated during the previous update interval, Yₜ₋₂ is the standard deviation for the period preceding the previous update interval, and so forth. Standard deviation Yₜ₋ₙ is a standard deviation for an arbitrary update interval, and n is an integer greater than 2. The value of Wₜ may be calculated in accordance with any one of equations 902, 904, and 906, which are shown in FIG. 9. Similarly, the value Wₜ corresponds to the current update period, the value Wₜ₋₁ corresponds to the previous update period, and so forth.

In applying model 900, allocator 192 may calculate the value W for a plurality of update intervals and determine if the difference is significantly increasing or decreasing over these intervals. If the difference is significantly increasing or decreasing, allocator 192 may determine that the estimate E (determined during the most recent iteration of step 808) has poor consistency, in which case process 800 would execute step 826 before returning to step 808. Otherwise, allocator 192 may determine that the estimate E (determined during the most recent iteration of step 808) has a good consistency, in which case process 800 would skip step 826 and return to step 808 directly. As used herein, the term “significantly increasing or decreasing refers to a change of over 15% in either direction between two consecutive update intervals.

In one example, allocator 192 may calculate the values of Wₜ and Wₜ₋₁. Next, allocator 192 may calculate the difference between the two values. If the absolute value of the difference is greater than a threshold, allocator 192 may determine that the estimate E (determined during the most recent iteration of step 808) has poor consistency, in which case process 800 would execute step 826 before returning to step 808. Otherwise, allocator 192 may determine that the estimate E (determined during the most recent iteration of step 808) has a good consistency, in which case process 800 would skip step 826 and return to step 808 directly.

Although, in the present example, allocator 192 determines two values W for the current and previous update periods, in an alternative implementation, allocator 192 may calculate a plurality of values W, wherein each of the values W corresponds to a different update period in a sequence of update periods, ending at the current update period. In such implementations, allocator 192 may perform linear fitting on the values, determine the slope of the resultant line, and compare the slope against a threshold. If the absolute value of the slope is greater than the threshold, allocator 192 may determine that the estimate has a good consistency. Otherwise, allocator 192 may determine that the estimate has poor consistency.

A discussion is now provided of different models for assessing accuracy, as specified by step 818 of process 800 (shown in FIG. 8). In one example, step 818 may be executed by calculating the difference (E−A) between the estimated supply E (determined at the most recent iteration of step 808) and the actual supply (determined at the most recent iteration of step 814). If the difference is less than zero, allocator 192 may determine that the supply estimate is an undershot estimate. If the difference is greater than zero, allocator 192 may determine that the supply estimate is an overshot estimate. And if the difference is equal to zero, allocator 192 may determine that the supply estimate is neither an undershot nor an overshot. Alternatively, if the difference is less than a threshold T1, allocator 192 may determine that the supply estimate is an undershot estimate. If the difference is greater than a threshold T2, wherein T2>T1, allocator 192 may determine that the supply estimate is an overshot estimate. And if the difference is between thresholds T1 and T2, allocator 192 may determine that the supply estimate is neither an undershot nor an overshot.

FIG. 10 provides an example of a model 1000, which can be used to determine accuracy with greater precision. Model 1000 defines a residual value variable Rₜ and a value Wₜ. As illustrated by equation 1002, variable Rₜ is equal to the difference between the estimate Eₜ of resource supply in update interval t and the actual supply of the resource that is measured during update interval t. Model 1000 further defines a variable Wₜ, which measures the amount of white noise that is present in the values R. The index of variable Rₜ identifies the update period that corresponds to the variable. In this regard, Rₜ corresponds to the current update interval, Rₜ₋₁ corresponds to the previous update interval, and Rₜ₋₂ corresponds to the period preceding the previous update period, and so forth. Variable Rₜ₋ₙ corresponds to an arbitrary update interval n, where n is an integer greater than 2. The value of Wₜ may be calculated in accordance with any one of equations 1004, 1006, and 1008, which are shown in FIG. 10. Similarly, the value Wₜ corresponds to the current update interval, the value Wₜ₋₁ corresponds to the previous update period, and so forth.

In applying model 1000, allocator 192 may calculate the value W for a plurality of update intervals and determine if the difference is significantly increasing or decreasing over these intervals. If the difference is significantly increasing allocator 192 may determine that the estimate E (determined during the most recent iteration of step 808) is an overshot estimate. If the difference is significantly decreasing, allocator 192 may determine that the estimate E (determined during the most recent iteration of step 808) is an undershot estimate. As used herein, the term “significantly increasing” refers to an increase of over 15%, and the term “significantly decreasing” refers to a decrease of over 15%.

In one example, allocator 192 may calculate the values of Wt and Wt−1. Next, allocator 192 may calculate the difference between the two values. If the difference is below a threshold T1, then allocator 192 may determine that the estimate E is an undershot. If the difference is above a threshold T2, where T2>T1, then allocator 192 may determine that the estimate E is an overshot. If the difference is between thresholds T1 and T2, then allocator 192 may determine that the estimate is neither an overshot estimate nor an undershot estimate.

Although in the present example, allocator 192 determines two values W that correspond to the current and previous update periods, in an alternative implementation, allocator 192 may calculate a plurality of values W, wherein each of the values W corresponds to a different update period in a sequence of update periods, ending at the current update period. In such implementations, allocator 192 may perform linear fitting on the values, determine the slope of the resultant line, and compare the slope against thresholds T1 and T2, wherein T2>T1. If the slope is below threshold T1, allocator 192 may determine that the estimate E is an undershot estimate; if the slope is above threshold T2, allocator 192 may determine that the estimate is an overshot estimate; and if the slope is between thresholds T1 and T2 then allocator 192 may determine that the estimate E is neither an undershot estimate nor an overshot estimate.

Referring to FIG. 11, in some embodiments, a device 1100 may include processor 1102, volatile memory 1104 (e.g., RAM), non-volatile memory 1106 (e.g., a hard disk drive, a solid-state drive such as a flash drive, a hybrid magnetic and solid-state drive, etc.), graphical user interface (GUI) 1108 (e.g., a touchscreen, a display, and so forth) and input/output (I/O) device 1120 (e.g., a mouse, a keyboard, etc.). Non-volatile memory 1106 stores computer instructions 1112, an operating system 1116 and data 1118 such that, for example, the computer instructions 1112 are executed by the processor 1102 out of volatile memory 1104. Program code may be applied to data entered using an input device of GUI 1108 or received from I/O device 1120.

FIGS. 1A-11 are provided as an example only. In some embodiments, the term “I/O request” or simply “I/O” may be used to refer to an input or output request. At least some of the steps discussed with respect to FIGS. 1-11 may be performed in a different order, in parallel, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. The acronym RAID, as used throughout the disclosure, means “Redundant Array of Independent Disks”. In the example of FIGS. 1A-7, storage system 133 is a content-addressable storage system. However, the concept and ideas presented throughout the specification can be applied to location-addressable storage systems and/or any other suitable type of storage system. As used throughout the disclosure, the term “thread” refers to any series of processor executable instructions irrespective of how the instructions or scheduled or how memory for the execution of the instructions is allocated. In this regard, the terms “thread” or “process” are used interchangeably for the purposes of the present disclosure.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus. In the example of FIGS. 1A-8, storage system 133 is a content-addressable storage system. However, the concept and ideas presented throughout the specification can be applied to location-addressable storage systems and/or any other suitable type of storage system.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method for use in a computing system including a first component that is configured to allocate a resource of the computing system, the method comprising:
calculating a long-term moving average of a supply of the resource;
calculating a medium-term moving average of the supply of the resource;
calculating a short-term moving average of the supply of the resource;
detecting a trend of the supply of the resource based on the long-term moving average, the medium-term moving average, and the short-term average; and
enabling a second component of the computing system for pre-allocating the resource based on an outcome of the detecting, wherein the second component is enabled in response to the detected trend being a convergent trend,
wherein the second component is configured to at least in part supplement the functions of the first component.

2. The method of claim 1, further comprising disabling the second component of the computing system in response to detecting that the trend is a convergent trend.

3. The method of claim 1, wherein the trend is a divergent trend when the medium-term moving average exceeds the short-term moving average by a first threshold and the long-term moving average exceeds the medium-term moving average by a second threshold.

4. The method of claim 1, further comprising:
detecting a first difference between a first standard deviation of the supply and a second standard deviation of the supply, the first standard deviation occurring in a first period, and the second standard deviation occurring in a second period; and
decreasing a frequency at which the resource is pre-allocated by the second component based on the first difference.

5. The method of claim 1, wherein the resource is pre-allocated in each of a plurality of periods, the method further comprising:
detecting a first difference between a projected value of the supply in a first time period and an actual value of the supply in the first time period;
detecting a second difference between a projected value of the supply in a second time period and an actual value of the supply in the second time period;
calculating a third difference between the first difference and the second difference; and
adjusting an amount by which the second component is pre-allocating the resource based on the third difference.

6. The method of claim 1, further comprising:
calculating a projected value of the supply for a given time;
obtaining an actual value of the supply at the given time; and
adjusting an amount by which the second component is pre-allocating the resource based a difference between the projected value and the actual value.

7. The method of claim 1, wherein the resource includes one of a central processing unit (CPU) time, a message buffer resource, and a cache slot resource.

8. A system, comprising:
a memory; and
at least one processor that is operatively coupled to the memory, the at least one processor being configured to perform the operations of:
executing a first component of the system that is configured to allocate a resource of the system;
calculating a long-term moving average of a supply the resource;
calculating a medium-term moving average of the supply of the resource;
calculating a short-term moving average of the supply of the resource;
detecting a trend of the supply of the resource based on the long-term moving average, the medium-term moving average, and the short-term average; and
enabling a second component of the system for pre-allocating the resource based on an outcome of the detecting, wherein the second component is enabled in response to the detected trend being a convergent trend,
wherein the second component is configured to at least in part supplement the functions of the first component.

9. The system of claim 8, wherein the at least one processor is further configured to perform the operation of disabling the second component of the system in response to detecting that the trend is a convergent trend.

10. The system of claim 8, wherein the trend is a divergent trend when the medium-term moving average exceeds the short-term moving average by a first threshold and the long-term moving average exceeds the medium-term moving average by a second threshold.

11. The system of claim 8, wherein the at least one processor is further configured to perform the operations of:
detecting a first difference between a first standard deviation of the supply and a second standard deviation of the supply, the first standard deviation occurring in a first period, and the second standard deviation occurring in a second period; and
decreasing a frequency at which the resource is pre-allocated by the second component based on the first difference.

12. The system of claim 8, wherein the at least one processor is further configured to perform the operations of:
detecting a first difference between a projected value of the supply in a first time period and an actual value of the supply in the first time period;
detecting a second difference between a projected value of the supply in a second time period and an actual value of the supply in the second time period;
calculating a third difference between the first difference and the second difference; and
adjusting an amount by which the second component is pre-allocating the resource based on the third difference.

13. The system of claim 8, wherein the at least one processor is further configured to perform the operations of:
calculating a projected value of the supply for a given time;
obtaining an actual value of the supply at the given time; and
adjusting an amount by which the second component is pre-allocating the resource based a difference between the projected value and the actual value.

14. The system of claim 8, wherein the resource includes one of a central processing unit (CPU) time, a message buffer resource, and a cache slot resource.

15. A non-transitory computer-readable medium storing one or more processor-executable instructions, which, when executed by at least one processor of a system, cause the at least one processor to perform the operations of:
executing a first component of the system that is configured to allocate a resource of the system;
calculating a long-term moving average of a supply of the resource;
calculating a medium-term moving average of the supply of the resource;
calculating a short-term moving average of the supply of the resource;
detecting a trend of the supply of the resource based on the long-term moving average, the medium-term moving average, and the short-term average; and
enabling a second component of the system for pre-allocating the resource based on an outcome of the detecting, wherein the second component is enabled in response to the detected trend being a convergent trend,
wherein the second component is configured to at least in part supplement the functions of the first component.

16. The non-transitory computer-readable medium of claim 15, wherein the one or more processor-executable instructions, when executed by the at least one processor, further cause the at least one processor to perform the operation of disabling the second component of the system in response to detecting that the trend is a convergent trend.

17. The non-transitory computer-readable medium of claim 15, wherein the trend is a divergent trend when the medium-term moving average exceeds the short-term moving average by a first threshold and the long-term moving average exceeds the medium-term moving average by a second threshold.

18. The non-transitory computer-readable medium of claim 15, wherein the one or more processor-executable instructions, when executed by the at least one processor, further cause the at least one processor to perform the operations of:
detecting a first difference between a first standard deviation of the supply and a second standard deviation of the supply, the first standard deviation occurring in a first period, and the second standard deviation occurring in a second period; and
decreasing a frequency at which the resource is pre-allocated by the second component based on the first difference.

19. The non-transitory computer-readable medium of claim 15, wherein the one or more processor-executable instructions, when executed by the at least one processor, further cause the at least one processor to perform the operations:
detecting a first difference between a projected value of the supply in a first time period and an actual value of the supply in the first time period;
detecting a second difference between a projected value of the supply in a second time period and an actual value of the supply in the second time period;
calculating a third difference between the first difference and the second difference; and
adjusting an amount by which the second component is pre-allocating the resource based on the third difference.

20. The non-transitory computer-readable medium of claim 15, wherein the one or more processor-executable instructions, when executed by the at least one processor, further cause the at least one processor to perform the operations:
calculating a projected value of the supply for a given time;
obtaining an actual value of the supply at the given time; and
adjusting an amount by which the second component is pre-allocating the resource based a difference between the projected value and the actual value.
